(19) United States
(12) Patent Application Publication
(10) Pub. No.: US 2015/0076266 A1
(43) Pub. Date: Mar. 19, 2015

(54) DRUM ASSEMBLY AND METHOD OF LAYING A LINE ON A DRUM

(71) Applicant: DEEP TEK WINCH IP LIMITED, Newport-on-Tray, Fife (GB)

(72) Inventors: Alexander Charles Crawford, Newport-on-Tay (GB); Patrick John Crawford, Cupar (GB); Andrew Crawford, Balmerino (GB)

(21) Appl. No.: 14/387,681

(22) PCT Filed: Mar. 28, 2013
(86) PCT No.: PCT/GB2013/050845

§ 371 Date: Sep. 24, 2014

(30) Foreign Application Priority Data
Apr. 3, 2012 (GB) 1205986.1

(51) Int. Cl. B66D 1/38; B66D 1/52

(52) U.S. Cl. CPC B66D 1/38; B66D 1/52
USPC 242/156.1; 242/157.1

(57) ABSTRACT

A drum assembly and a method of laying a line (L) onto a drum (D) uses an oscillator device to apply vibrations to the line as it is being wound onto the drum. The oscillator device (17) sequentially increases and decreases the load on the rope as it is being wound onto the drum, causing differential fluctuations in the tension of the line as the line is diverted away in opposite directions from a straight line path to the drum. The vibrations typically cause a rapidly alternating load on the line, which is additional to any load applied to the line during laying of the line onto the drum. This alternating load typically reduces the available stretch in the line, and therefore assists in compaction of the line on the drum.

This invention relates to a drum assembly and to a method to compact a line (for example a rope of wire or fibre) that is to be spooled onto a drum.

When lines such as wire or fibre ropes are spooled onto a drum under loads the rope tends to compact on the drum. When the line is compacted, it is forced into a densely packed profile and the circumference of the line reduces. Often the cross-sectional profile of the line will deform under load in different ways, for example, flattening onto the surface of a drum or optionally nesting into grooves formed by the radially outer surfaces of previous layers of rope, normally conforming to the shape of the surface onto which it is being laid. Rope under light loads compacts less than rope under heavy loads. Compaction of the rope is often desirable, as when the rope is compacted it is denser and takes up less space on the drum, allowing easier laying of the rope on the drum, more rope to be laid per drum, and/or the use of smaller drums that are easier to handle. However, uneven compaction of the line on the drum can cause problems when successive layers are spooled under different loads. For example a rope can often be wound onto the drum under a relatively light load (causing minimal compaction in inner layers of the rope on the drum), but then lowered under a heavy load, which causes the outer layers of rope to be more compacted than the underlying inner layers. This typically occurs when heavy pieces of equipment are lowered to the seabed (spooling out the rope from the drum), where the load is detached from the hook, and then the rope is retrieved back to surface under low tension with the rope bearing only the weight of the hook so there is relatively little compaction of the rope on the drum when the hook is recovered to surface, before the rope is then used to lower another heavy object to the sea bed.

When the second heavy load is lowered to the seabed, the outer layers of rope being spooled off the drum are under high tension and exhibit high compaction, whereas the underlying inner layers that were wound onto the drum at lower tension exhibit lower compaction. The effect of this is that during lowering of the second heavy load, the highly tensioned outer layers of rope may cut radially down through the underlying lower-tension inner layers on the drum. Also, the outer layers of rope under higher tension may tend to slip circumferentially around the drum as the rope is paid out. This causes abrasion on the rope and an uneven lowering speed.

To assist in reducing this problem many cranes use heavy weights attached to the hook allowing sufficient weight when hoisting the un-loaded hook. Typically these loads can weigh 10% of the maximum working load of the crane, and up to 20% in the case of cranes operating with fibre ropes. Dead weights on the hook may weigh 15 tonnes on a 150 tonne crane operating with wire rope, and up to 30 tonnes for a fibre rope on the same rating of crane.

Also mooring ropes and other ropes are typically pre-stretched, or ‘conditioned’ before being deployed. Fibre ropes for use on cranes are generally pre-tensioned up to 20% of the maximum working load prior to use. With wire rope the normal pre-tensioning load is around 10% of the maximum working load.

Conditioning of mooring ropes before use is generally carried out on large and expensive traction winch facilities that are often fixed in set locations because of their size. During this conditioning the mooring ropes are subjected to loads as close to 100% of the maximum working load as can be achieved by the traction winch facility, and even up to 50% of the breaking load is considered to be beneficial.

According to the present invention there is provided a drum assembly configured to receive a line, the drum assembly having an oscillator device adapted to apply vibrations to the line as the line is being received onto the drum.

The drum can be a winch drum or a storage drum.

Typically the vibrations are applied to the line as it is being wound onto the drum, typically when in tension. Typically the line is tensioned close to its limit while the vibrations are being applied, for example, within 5-10% of the maximum load limit of the line. Typically the line is tensioned to the maximum available tension while the vibrations are being applied.

The oscillator device can be arranged to apply vibrations to a device that engages the line, such as a head of the oscillator device. Optionally the oscillator head can be a guide device that guides and optionally diverts the path of the line, such as a sheave or roller. Optionally the oscillator head can comprise a track device, which optionally has an endless track configured to circulate around rollers when pressed against the line, whereby the track device applies a force tending to urge the line in a direction parallel to the axis between the rollers. The track devices can be applied to the line singly or in opposed pairs, with the line between them.

Optionally the oscillator device can be arranged to apply vibrations to the drum, typically to the portion of the drum that is receiving the line, and typically so that the line is disposed between the oscillator device and the drum, with the portions of the line being vibrated being in contact with both the oscillator device and the outer surface of the drum, which can optionally comprise a layer of line that is laid onto the drum.

Typically the line can be a rope, typically a fibre rope made from synthetic or natural organic fibres. Optionally the rope can be a wire rope, made from non-organic (e.g. metallic) fibres.

Typically the vibrations are applied in a plane that is perpendicular to the plane of the line.

Typically the plane of the oscillations is generally perpendicular to the axis of the drum, so that at the peaks of the oscillations, the line typically experiences higher tensions than when the line is in the mid point between the peaks of the oscillations.

Typically the line is wound onto the drum while the line is being vibrated by the oscillator device.

The oscillator device typically momentarily and sequentially increases and decreases the load on the rope as it is being wound onto the drum, causing differential fluctuations in the tension of the line as the line is diverted away in opposite directions from a straight-line path to the drum.

The vibrations applied to the line may align the fibres in the line prior to the line being laid on the drum, which typically provides a more compact arrangement of the line on the drum.

The vibrations typically cause a drop in friction between the fibres allowing them to align better within the axis of the line. Typically the circumference of the rope is reduced and the compaction of the individual fibres within the line is increased, increasing the density of the line as it is being applied to the drum, in a consistent manner, so as to increase the consistency in the compaction of the line on the drum, between different layers.

The vibrations typically cause a rapidly alternating load on the line, which is additional to the load applied to the line during laying onto the drum. This alternating load typically reduces the available stretch in the line, and therefore assists in compaction.

The vibrations can be applied as a sine wave (with diversions in equal and opposite directions) or as other waves, for example as saw tooth waves, with diversions of the line only in a single direction, or as complex waves, for example, with diversions in each direction, but the amplitude of such diversions is not necessarily equal. The diversions can be graduated, like sine waves, with gradually increasing amplitude to reach a peak followed by a graduated fall, but in other cases, e.g. saw tooth waves and square waves, the amplitude of the vibrations can change rapidly and substantially instantaneously.

Optionally the line may pass over a guide device typically in the form of a roller device such as a sheave or a roller before being laid on the drum. The guide device may optionally have a groove, and in certain examples, the profile of the groove on the sheave can optionally be configured to lay the rope in a particular desired cross-sectional shape on the drum for beneficial compaction of the new layers of line being laid on the underlying layers of line. The line can optionally be pressed into the groove in order to impose the profile of the groove onto the line, prior to the laying of the line on the drum. The profile of the line coming off the sheave or other guide device can be adjusted by adjusting the force with which the line is pressed into the profile of the groove. For example the groove on the sheave can have a profile that changes the shape of the line when it is laid on the drum. In the case of a wire rope the groove is typically a supporting groove, with a continuous arcuate cross-sectional profile, which supports the line at all points on the arc. A fibre rope is typically formed as a sleeve (with a cross section that is circular or oval) formed from multiple strands of fibre line. Fibre rope normally compacts better into a flatter profile so by providing the groove with a flat bottom, and arcuate sides, the radially outer surface of the rope is typically flatter and therefore the fibre rope comes off the sheave in a relatively flattened profile close to the profile best suited for a compact configuration on the drum. In some examples, the line is constrained in the groove to adopt the profile of the groove, which can be advantageous for line compaction on the drum. For example, the groove in the sheave can be an open groove with side walls and an opening which can be closed by a closure device such as a separate guide member, e.g. another sheave with a groove, or a plate or a track that closes the opening to the groove, and typically urges the line into the groove on the sheave to force the line to adopt a particular cross sectional profile that is dictated by the groove profile, and which is typically advantageous for line compaction on the drum. For example, where the guide device comprises two sheaves with opposed grooves, the gap between the sheaves can be controlled to compress the line to different extents, so that a specific height of line can be laid on the drum as it leaves the sheaves. When the line is under relatively low tension it typically has a reduced tendency to flatten as it leaves the sheave, so by controlling the spacing between the sheaves and typically by making this distance adjustable it is possible to obtain more consistent line profiles (e.g. consistently flat) on the drum even when the tension applied to the line changes during laying of the line on the drum. The guide device can comprise rollers instead of or in addition to sheaves; optionally the rollers can have grooves, but in certain examples, the rollers have cylindrical profiles, without grooves on their surfaces. Optionally the guide devices have adjuster mechanisms to adjust the spacing between the guide devices, and to adjust the compression applied to the line between the adjusters, thereby allowing control of the flattening effect of the guide devices on the line. Optionally the line passes through a set of rollers that vibrate the line and compress it between the rollers as the line is laid onto the drum. The rollers can optionally track the movement of the line on the drum as the layers of line build up on the drum in order to maintain a consistent angle of incidence between the line and the drum.

Typically the guide device moves the line parallel to the axis of the drum (e.g. horizontally if the drum axis is horizontal) in order to lay the line on the drum in sequential rows in each layer. Typically the guide device can be motorised to drive the horizontal movement of the guide device to spool the line onto the drum. The speed of horizontal movement of the guiding device can be varied in order to control the width of the rows of line in each layer.

Typically the guide device can move perpendicular to the axis of the drum (e.g. vertically) to maintain a consistent angle of incidence of the line on the drum.

In typical examples of the invention, the oscillator device is fitted as close to the drum as possible.

Optionally the oscillator device generates the vibrations, and is typically disposed in an oscillator head that is applied to the line to apply the vibrations to the line as it is being laid on the drum. Vibrations are typically directly applied to the line, typically by the oscillator head. The line therefore experiences more vibrations, or more intense vibrations, than the drum and other parts of the assembly.

The oscillator device typically acts on the line to change the alignment of the line materials to increase their alignment with the axis of the line.

Optionally, the oscillator device helps to compact the fibres or strands making up the line material and help to tension the line as it is laid onto the drum thereby creating a more compact line that forms tighter layers on the drum. This typically reduces line slippage on the outer layers and increases the consistency of the degree of compression and compaction and slippage of the line between outer and inner layers. Therefore, there is typically less variation in the compaction between inner and outer layers of the line and the line behaves more consistently when it is recovered with a light load and paid out with a heavy load.

The frequency of the vibrations can be varied to suit different rope circumferences and construction as well as the different hoisting speeds. By varying the frequency of vibration the maximum compaction can be obtained. Typically for a rope diameter of 2-3 cm with tension of 1 tonne, a suitable frequency can be 25 Hz. The frequencies useful for different examples are likely to be between 15 and 500 Hz. Different results can be obtained also by varying the amplitude. At high amplitude, relatively low frequencies of vibration in a range of 20 to 50 Hz are effective. With lower amplitudes, higher frequencies can be used, for example 300-500 Hz. Each line is likely to vary with its different construction, diameter, circumference, and coefficient of friction between fibres. As the frequency can be easily varied the optimum frequency can easily be determined for each case by changing the frequency with the rope travelling under a fixed speed and known tension the circumference can be measured to discover the maximum compaction for that rope. Similar tests can be conducted to determine the optimal amplitude and phase.

The oscillator device may incorporate at least one rotating eccentric weight. Alternatively, or additionally, the oscillator device can optionally be triggered by electrical, hydraulic or pneumatic pulses or signals. Different kinds of oscillator device can be used without departing from the scope of the invention.

In most examples the frequency of vibration may be controlled and in this way it is possible to have a single mechanism working at its maximum efficiency or two or more mechanisms working in sequence with each other or working in opposition to each other, for example, depending on whether both are working on the same side of the rope or on opposite sides of the rope.

Optionally the oscillator device can apply oscillations in more than one direction. Optionally the oscillator device can comprise more than one oscillator. Optionally where more than one oscillation is applied to the line by the oscillator device, the oscillations are in the same phase, but optionally they could be in different phases. Typically the amplitudes of different oscillator devices are the same, but optionally could be different. Typically the frequencies of different oscillator devices are the same, but optionally could be different.

Optionally where more than one oscillation is applied the two oscillator devices can be of the same or a different type, e.g. rotary or linear. It is typically beneficial that the sum of the amplitude of the vibrations works to stretch the rope, so arranging several oscillator devices to work in phase, but in opposite directions, e.g. in a loop, is particularly effective.

The oscillator device is typically used for laying the rope on the drum under light loads. The oscillator device typically has most effect in compacting the rope when the tension of the rope is at its greatest available tension.

The oscillator device may optionally be arranged so that if required it can be moved clear of the line and optionally clear of the drum when it is not required, for example, when the rope is being paid out or hoisted with a heavy load. For example, the oscillator device (or sheave or other guide device on which it acts to transmit oscillations to the line) can be mounted on a hinge mechanism permitting swinging movement of the guide device or the oscillator device in and out of the path of the line.

Typically the oscillator device applies the vibrations to the line (and/or the drum) when the line is being laid on the drum and does not apply vibrations to the line as it is being paid out from the drum.

The oscillation device can comprise an electric, pneumatic or hydraulic oscillator device, typically comprising a reciprocating member such as a rotary flywheel or piston. The oscillator device typically works best when vibrations are applied in a vertical plane, so that gravity assists in the downward phase of the vibrations. The frequency is altered in the rotary oscillator by increasing the rotary speed. In a well-lubricated line higher frequencies are very effective but in some lines with a high friction coating lower frequencies and typically higher amplitudes appear to be more effective. A piston-type oscillator device is more suited to delivering a shock wave type impact to the rope although it can also be used for high frequency. In the case of a fibre rope the hydraulically powered rotary oscillator device has been found to be most suitable as the frequency range is high and the frequency is altered simply by controlling the flow of hydraulic oil that allows the most suitable frequency for a specific rope size and construction to be found. It is normally found that the smaller the oscillator device, the higher the frequency. The higher frequency is also more easily confined to the line whereas low frequencies tend to be transmitted more easily to the associated equipment (brackets etc).

Examples of the invention are not limited to winch drums, and could be used in relation to storage drums, where line is being laid onto the drum for storage rather than for lifting or lowering a load. Examples of the invention are applicable especially to marine winches, but are not limited thereto, and certain examples are useful for land-based winches.

Optionally the oscillator device can also be built as a ‘stand alone’ unit for drums specifically when a rope is being conditioned prior to it being used as in the case of deep water mooring ropes, and wherein the oscillator device can optionally be removed from the drum after compaction of the line.

Vibrations can optionally be directional, e.g. linear across the axis of the line. Rotational oscillator devices (e.g. having a simple oscillator comprising a single shaft with an eccentric weight installed in the sheave) can also be used to apply non-linear vibrations to the line. Typically the rotational vibrations are applied in a single plane, typically a vertical plane.

Optionally the drum assembly has a line braking mechanism configured to apply back tension to the line as it is being laid on the drum. Optionally the line braking mechanism is variable, and the braking can be controlled. Typically the line braking mechanism can be applied to sheaves and/or rollers or other line guide devices that engage the line. Optionally the drum assembly can have a line-tensioning device, which may comprise the braking mechanism. Increasing the tension on the rope while laying it on the drum can typically enhance the effects of the vibrations applied to the line.

Optionally the profile of the groove on the sheave can also be configured to increase the tension or to shape the profile of the line for laying on the winch drum in a more predictable manner. For example, the groove on the sheave can optionally have side walls that typically form a ‘V’ profile, whereby the line assumes a deep V profile complementary to the groove. Improved braking of the sheave can be achieved by a deep V groove as the friction of the line relative to the sheave can thereby be increased. This improved braking may be required to increase the tension on the line as it is oscillated. A flat groove profile may be more suited when the line is intended to flatten on the drum as the sheave then prepares the rope in its most compacted form that is most suited to the drum. Typically the line is constrained, e.g. compressed into the groove to adopt the profile of the groove, and typically the sheave, roller or other guide device has a closure device that is movably mounted above the groove and which is typically movable relative to the groove to adjust the clearance between the groove and the closure device to adjustably press the line into the groove and force it to adopt the profile of the groove as it is laid onto the drum.

The material of any line guiding devices such as sheaves can optionally be configured to increase or reduce the friction between the line and the sheave or other line guide device. Typically higher frictional forces between the line and the guide devices can tend to increase the effect of the oscillator mechanism. Typical high friction surface materials include rubber and resilient plastics materials, including elastomers that are bonded to the surface of the sheave. The high friction material can be used to make the guide device as a whole, or can be applied to the surface.

Typically the assembly (optionally the oscillator device) can have a vibration damper to localise vibrations at the line, and typically to reduce or prevent their propagation or transmission to other parts of the drum or ancillary equipment. Typically the vibration damper can comprise a resilient device, and optionally can incorporate an elastomeric material to absorb vibrations and reduce or prevent their transmission to a holding arm or bracket attaching the oscillator device to other parts of the equipment, and focussing the vibrations on the line.

The line guiding devices (sheaves, rollers, tracks etc) in contact with the line may include tyres and may comprise friction increasing surface profiles. Optionally the tyres can be pneumatic. The line guiding devices can be adjustable relative to the path of the line in order to press the line into a groove on the line guiding devices.

The line guiding devices (e.g. sheaves, rollers, tracks etc) may include braking devices such as friction brakes, hydraulic brakes, electrical brakes or other braking devices to reduce the turning and twisting motion of the line on the sheave and if required to immobilise the line on the guiding device. A motor may be used to drive the sheave if required for spooling slack rope on a drum.

The line may optionally pass between several (e.g. two) guide devices such as plates similar to the track device, which may be vibrated individually or together, at the same or different frequencies, and in or out of phase, and the line can be vibrated when it is pulled between them onto the drum. The clearance between the plates or other guide devices can be adjusted to compress the line between them, typically into a groove on one or more of the guide devices.

In certain examples, the line may form a loop between adjacent guide devices, such as rollers or sheaves. The rollers or sheaves may typically be placed in the same plane, or in closely adjacent and parallel planes. One or more than one of the rollers or sheaves forming the loop can be arranged to be vibrated by the oscillator device. The relative positions of the rollers or sheaves forming the loop in the line can be adjusted in order to enlarge or contract the loop, and/or to compress the line between the guide devices. Typically, the oscillations are applied to one or more of the rollers or sheaves forming the loop in the plane that is parallel to the axis formed between the rollers or sheaves, whereby the oscillations increase and decrease the tension in the line in the loop.

The rollers or sheaves (where two or more are used) can have the same diameter, or a different diameter.

In certain examples, the line guiding devices (e.g. roller sheaves etc) can incorporate the oscillator device, e.g. within the barrel of the roller.

The invention also provides a method of laying a line on a drum, the method comprising applying vibrations to the line when laying it on the drum, whereby the line laid on the drum is compacted.

The invention also provides a method of treating a line, prior to use, comprising applying vibrations to the line.

Typically the line is laid on a drum prior to use, but this is not essential, and the line can be subjected to vibrations as the line is being deployed from a drum, or when it is being stored in a storage device, which can comprise a drum or a different line storage device. Typically the line can be tensioned and vibrated as the line (e.g. a mooring rope or a crane rope, which can typically be a fibre rope or a wire rope) is being deployed, e.g. paid out from a ship, or stored, e.g. laid on a drum. The line can be deployed from a drum or from a cable tank and is typically passed through a linear winch (typically comprising a traction device such as more than one pairs of tyres or tracks which engage the line between the tyres in each pair to grip the line, and which apply tension between the respective pairs of tyres to tension the line as it is being deployed. Typically the line can then be passed through an oscillator device such as an oscillator head as described herein, which can either be formed as a part of the traction winch, or can be a separate component, and which typically applies vibrations to the line as it is being tensioned, or as it goes over the side of the ship. The line can thus be subjected to vibration and tension from an oscillating head as the line passes from factory to ship or from ship to seabed via a linear winch.

Optionally the vibrations are applied to the line by an oscillator device, which is activated when the line is being laid on the drum and is typically de-activated when the line is being recovered from the drum.

The invention also provides apparatus for treating a line, prior to use, comprising an oscillation device configured to apply vibrations to a line.

The various aspects of the present invention can be practiced alone or in combination with one or more of the other aspects, as will be appreciated by those skilled in the relevant arts. The various aspects of the invention can optionally be provided in combination with one or more of the optional features of the other aspects of the invention. Also, optional features described in relation to one example can typically be combined alone or together with other features in different examples of the invention.

Various examples and aspects of the invention will now be described in detail with reference to the accompanying figures. Still other aspects, features, and advantages of the present invention are readily apparent from the entire description thereof, including the figures, which illustrates a number of exemplary aspects and implementations. The invention is also capable of other and different examples and aspects, and its several details can be modified in various respects, all without departing from the spirit and scope of the present invention. Accordingly, the drawings and descriptions are to be regarded as illustrative in nature, and not as restrictive. Furthermore, the terminology and phraseology used herein is solely used for descriptive purposes and should not be construed as limiting in scope. Language such as “including,” “comprising,” “having” “containing” or “involving” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes.

Any discussion of documents, acts, materials, devices, articles and the like is included in the specification solely for the purpose of providing a context for the present invention. It is not suggested or represented that any or all of these matters formed part of the prior art base or were common general knowledge in the field relevant to the present invention.

In this disclosure, whenever a composition, an element or a group of elements is preceded with the transitional phrase “comprising”, it is understood that we also contemplate the same composition, element or group of elements with transitional phrases “consisting essentially of”, “consisting”, “selected from the group of consisting of”, “including”, or is preceding the recitation of the composition, element or group of elements and vice versa.

All numerical values in this disclosure are understood as being modified by “about”. All singular forms of elements, or any other components described herein are understood to include plural forms thereof and vice versa.

In the accompanying drawings,

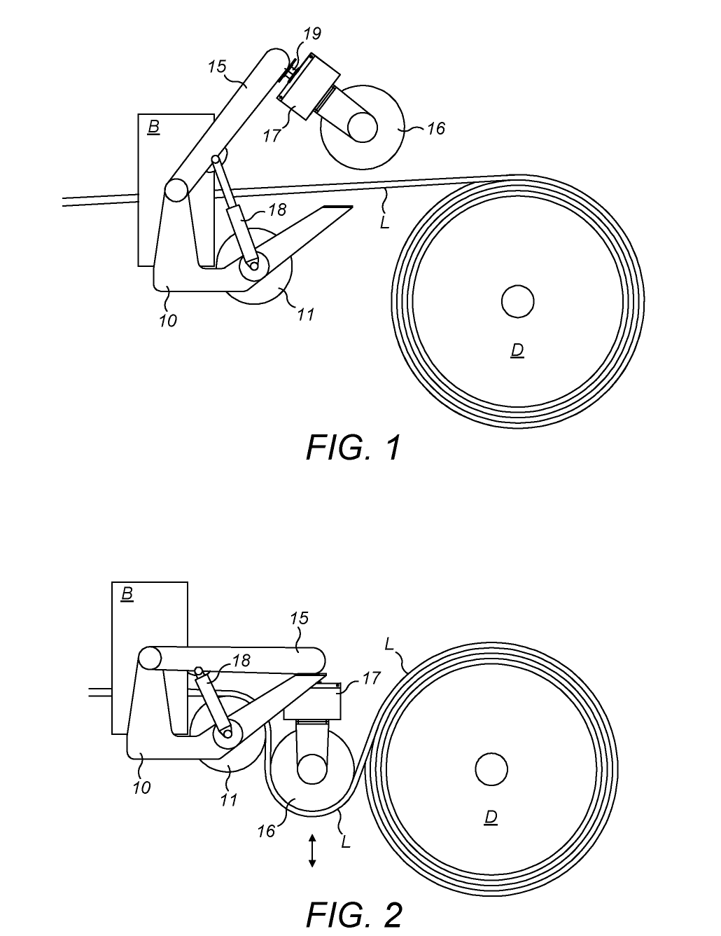

FIG. 1 is a side view of a drum assembly having a single vibrating sheave in the raised position;

FIG. 2 is a side view of the FIG. 1 drum with the sheave in the lowered position;

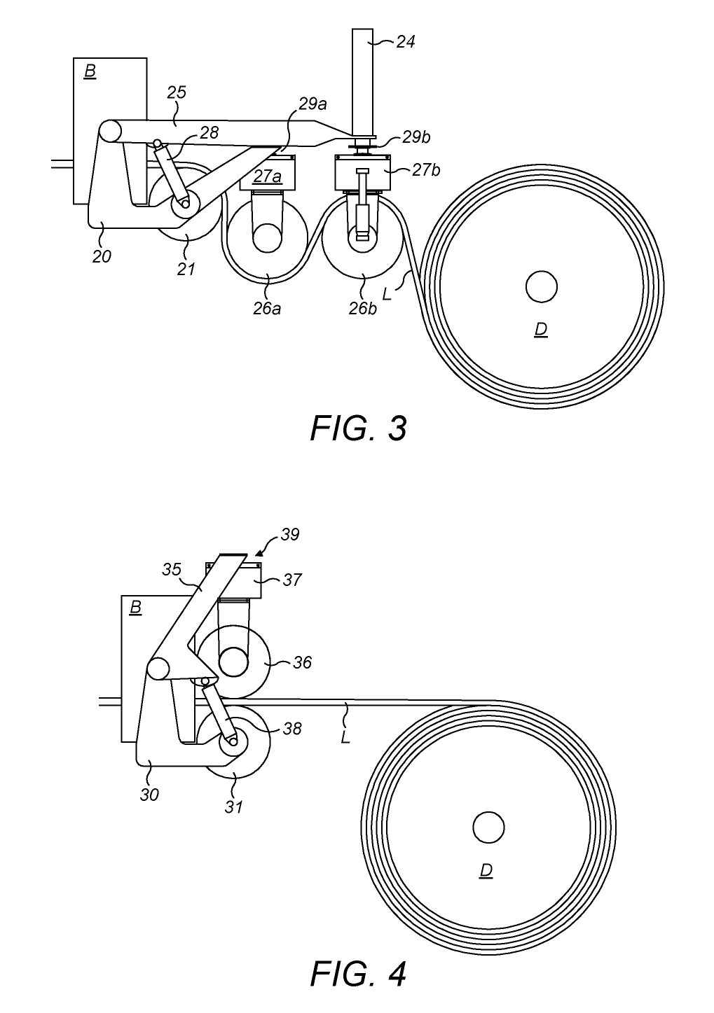

FIG. 3 is a side view of a modified form of the FIG. 1 drum with two vibrating sheaves;

FIG. 4 is a side view of a further modified drum having a different arrangement with a vibrating sheave arranged vertically above another sheave or roller;

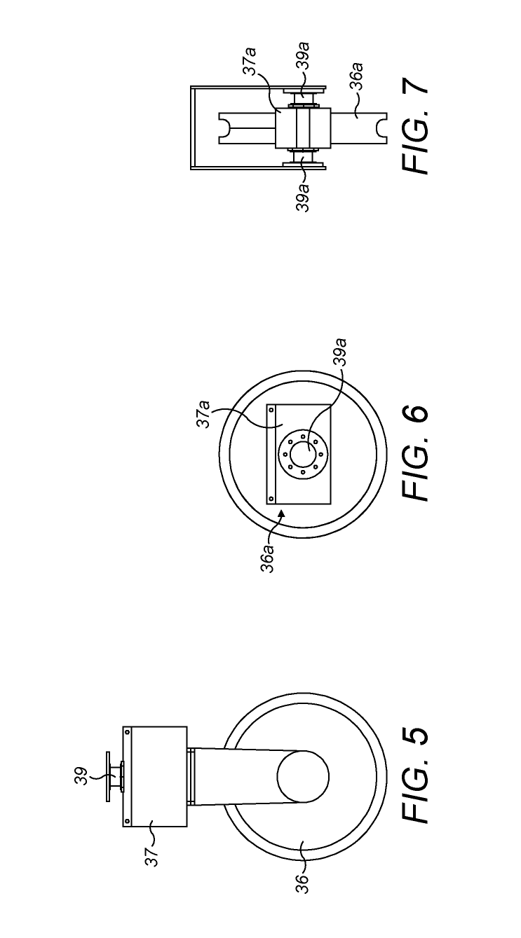

FIG. 5 shows a side view of the vibrating sheave used in the arrangements shown in FIGS. 1-4;

FIG. 6 shows a side view of an alternative design of vibrating sheave that could be used in the arrangements shown in FIGS. 1-4;

FIG. 7 shows a front view of the alternative design of vibrating sheave mounted in a mounting arm;

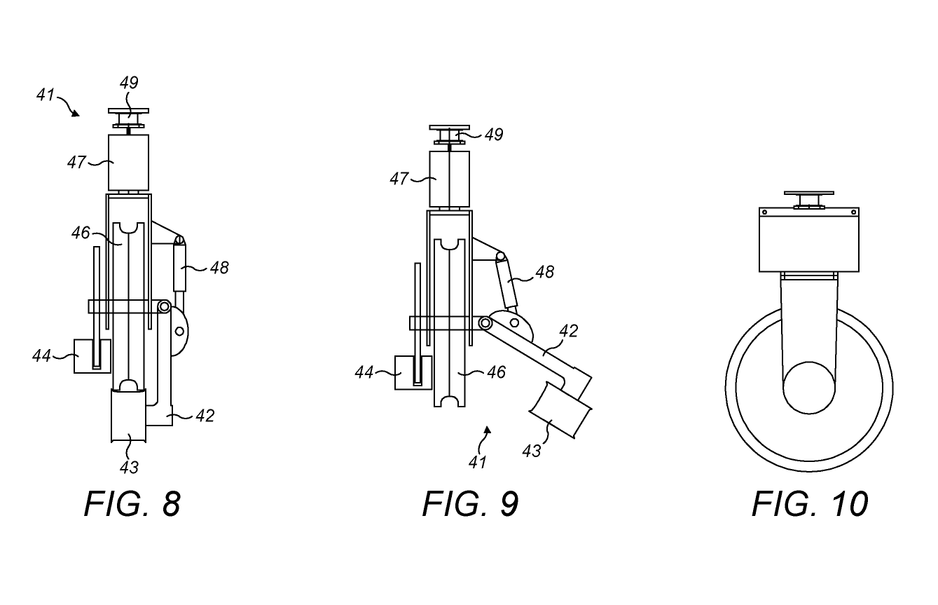

FIGS. 8-9 show front views of an alternative mounting arrangement for the sheave or roller of FIG. 1 showing a bottom roller swinging away in order that it can clear the line;

FIG. 10 shows a side view of an alternative mounting arrangement for the sheave or roller of FIG. 1 showing a hydraulic or electric hub brake applied to the sheave;

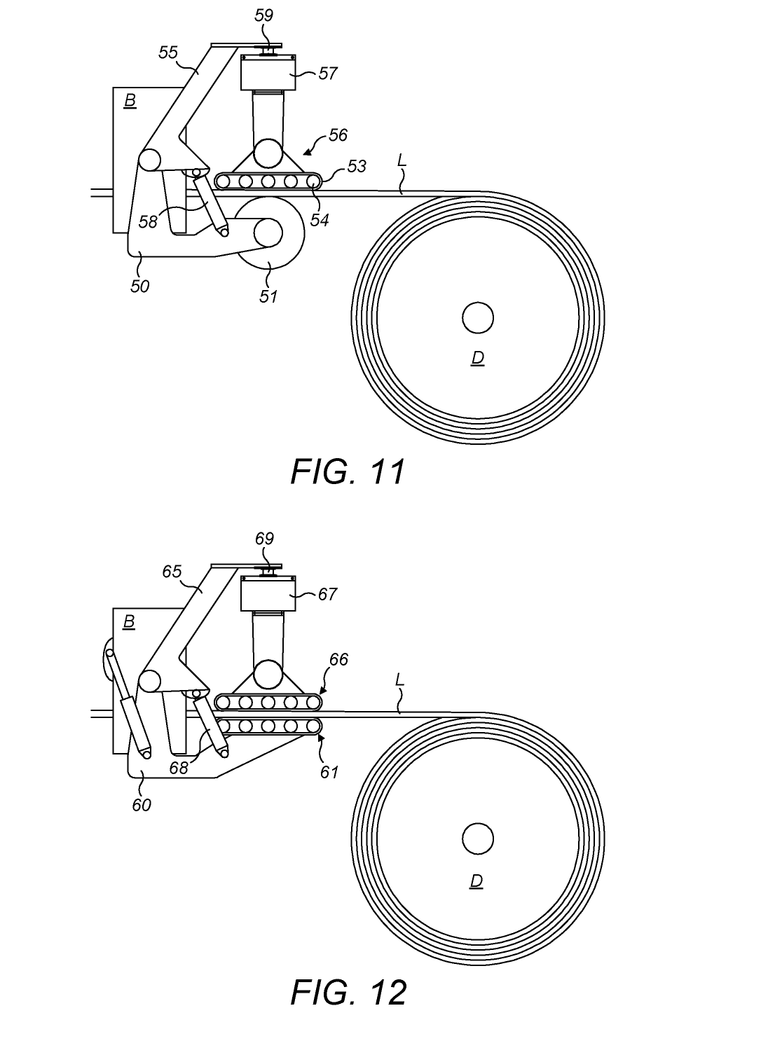

FIG. 11 shows an alternative design having a vibrating track device;

FIG. 12 shows an alternative design of vibrating track device;

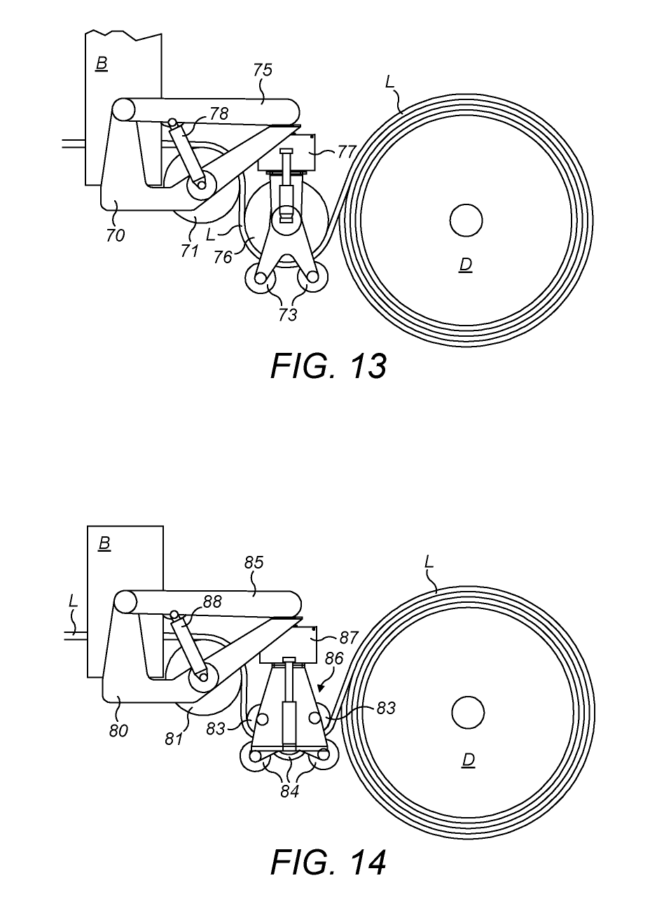

FIG. 13 shows an alternative design of drum assembly having a different arrangement of rollers beneath the sheave to trap the line against the sheave. Optionally the sheave may be braked to increase tension in the line;

FIG. 14 shows an alternative design of drum assembly having three rollers on the inside curve of the line and two on the outside curve of the line;

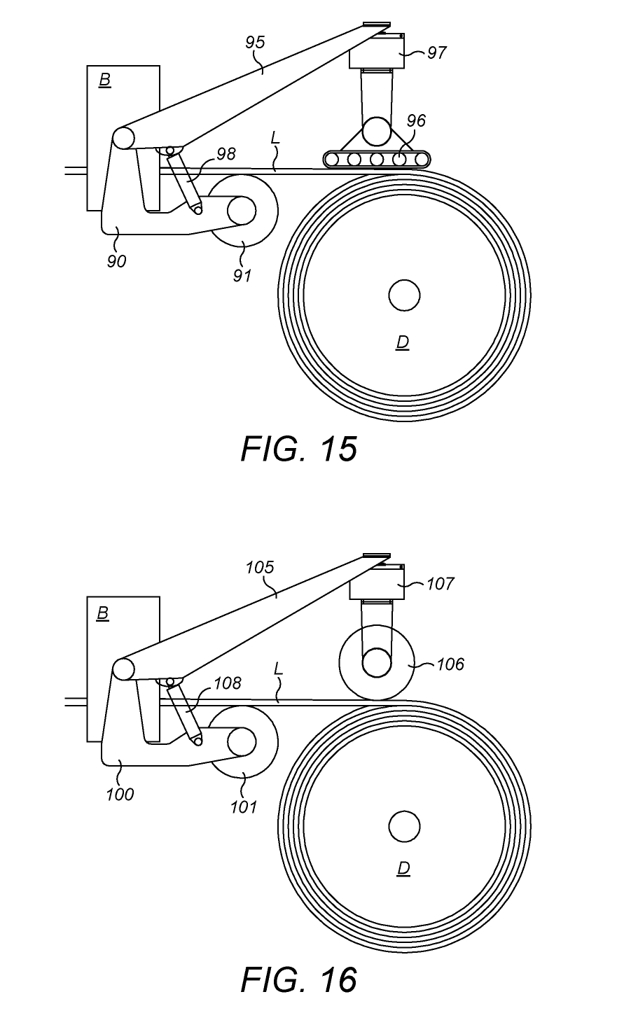

FIG. 15 shows an alternative design of drum assembly having a track device vibrating on the rope or the drum;

FIG. 16 shows an alternative design of drum assembly with the oscillator comprising sheaves or rollers vibrating on the drum and/or the line;

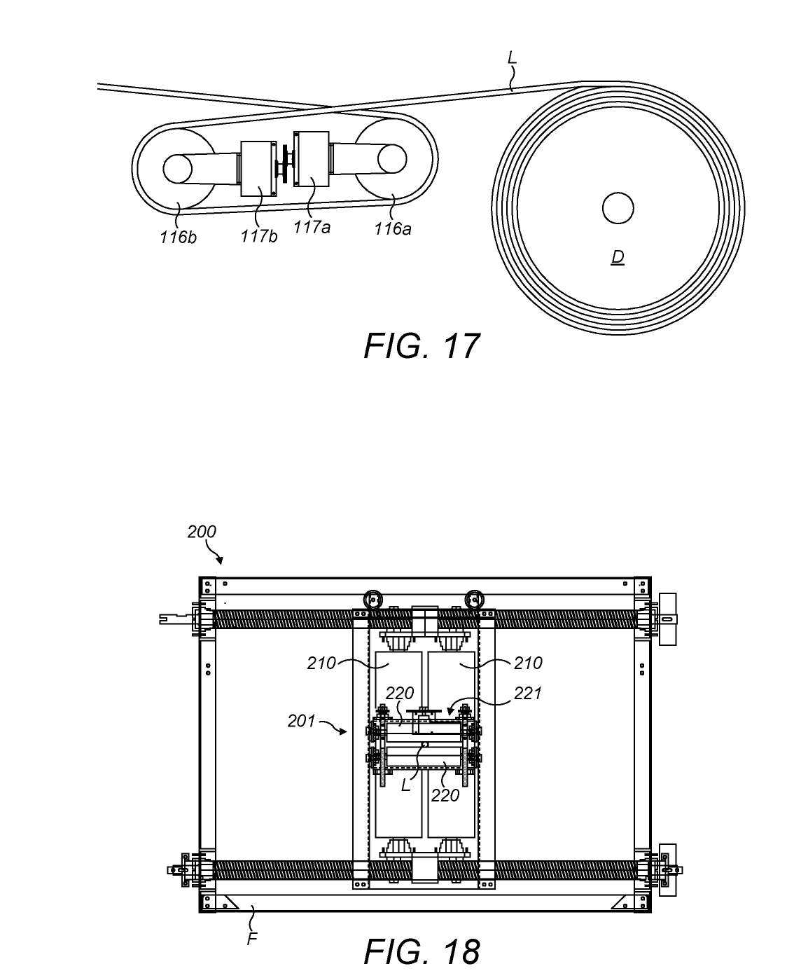

FIG. 17 shows an alternative design of drum assembly having two sheaves arranged to create a loop in the line and typically each of the sheaves being arranged to vibrate; and

FIGS. 18-20 show an alternative design of drum assembly, which has a further design of oscillating head that could be used in any of the drum assemblies in this disclosure.

Referring now to the drawings, FIG. 1 discloses a winch drum assembly having a winch drum D with an axis and a barrel that is parallel to the axis, for receiving a line to be laid onto the barrel. Shown schematically in the Figures, the drum D has side walls arranged at opposite ends of the barrel, which are not shown in the drawings for clarity, but which will be familiar to the skilled person.

In each of the drawings, the drum D is shown in side view, with the axis in the centre. The line L is laid onto the drum D in consecutive layers, so that the outer layers of the line L are laid on top of underlying layers that have already been laid onto the drum D. Typically, the line L is tensioned with a back tensioning device as it is being laid onto the drum D. Typically, the line L is laid onto the drum D by passing the line around (e.g. over or under) a guide device, typically comprising a sheave or roller. Typically, one or more sheaves or rollers are provided on the guide device. The sheaves or rollers typically spool from side to side as the line L is spooled onto the drum D in a general helix. Typically the pitch of the helix should be as low as feasible so that the drum D can accommodate the maximum amount of line L.

Referring now to FIG. 1 and FIG. 2, the assembly comprises an oscillator head having a guide device comprising a sheave arrangement mounted on a bracket B. The bracket B is typically mounted on the winch adjacent to the winch drum D. The bracket B has a static arm 10 and a hinged arm 15.

The static arm 10 is fixed to the bracket B and is arranged vertically underneath the hinged arm 15, and bears a passive guide device such as a roller or sheave 11, that is rotationally mounted on the static arm 10 by a pivot pin set typically in the horizontal plane, allowing the rotation of the guide roller or sheave 11 around the horizontal axis of the pin, in the vertical plane passing through the path of the line L.

The hinged arm 15 is typically hingedly connected to the bracket B by means of a pivot pin that is typically also mounted horizontally, so that the hinged arm 15 can swing in the vertical plane that is parallel to and intersecting with the path of the line L. The hinged arm 15 carries a further guide device in the form of a sheave or roller device 16. The sheave or roller device 16 on the hinged arm 15 carries an oscillator device 17, which could be a rotary oscillator for example, or a piston oscillator. Typically, a hydraulic cylinder 18 connects the hinged and static arms 15, 10. The oscillator device 17 is typically connected to the hinged arm 15 via a damper mechanism 19, which typically comprises a block or boss of resilient polymeric material such as rubber or a resilient plastics material, which serves to isolate any vibrations created by the oscillator device 17 from the hinged arm 15, and prevents the transmission of such vibrations through the hinged arm 15 and into the bracket B, to other components of the assembly. Other resilient devices such as springs could also be used. This focuses most of the vibrations generated by the oscillator device 17 on the sheave or roller 16, for optimal transmission of the vibrations to the line L. The active vibrating sheave 16 is mounted on the hinged arm 15 in the same plane as the passive sheave 11 mounted on the static arm 10, but is typically arranged vertically above the line L and the passive sheave 11 on the static arm 10 when the hinged arm 15 has been swung upwards clear of the line L as shown in FIG. 1.

When the apparatus is in use, the hydraulic cylinder 18 is operated to draw the hinged arm 15 downwards towards the path of the line L, so that the line L engages within a groove on the circumferential edge of the vibrating sheave or roller 16, and is pressed down over the passive sheave 11 on the static arm into the arrangement shown in FIG. 2, where the line L is forced to adopt a serpentine path having multiple turns and passing around the passive and active rollers 11 and 16, before being laid on the winch drum D. Thus the oscillator head applies vibrations directly to the line L. Optionally the groove is faced with a high friction material such as rubber. Typically, the free end of the hinged arm 15 furthest away from the hinged connection with the bracket B has side formations to engage with the outer end of the static arm 10, so as to set the lowered position of the vibrating sheave 16 in the FIG. 2 position, in a defined orientation. This forces the line L into the groove of the sheave 16 so that the line L adopts a similar cross-sectional profile to the groove as it comes off the sheave 16.

When the hinged arm 15 is in the lowered position shown in FIG. 2, and the line L is diverted from a straight path between the roller 11 and the winch drum D, the vibrations applied to the line by the oscillator device 17 sequentially increase and decrease the tension in the line L as it is being laid onto the drum D. The line L therefore vibrates in a general sine wave pattern and this is typically done at relatively high frequency to apply additional momentary tension increases onto the line L in the instant that it is being laid onto the drum D. This has the effect of increasing the compaction of the line L on the drum. By vibrating the line L in this way, at typical frequencies of 20-50 Hz, e.g. 25 Hz, the load on the line can be increased by 50% and the amount of line spooled onto the drum D can be increased by 10-15%. This increased compaction prevents the rope from cutting radially into underlying layers of line when a greater load is lowered and also reduces the total volume of rope on the drum because the overall density of the rope on the drum is greater.

Referring now to FIG. 3, the oscillator head has a modified hinged arm 25 pivotally connected to a bracket B, along with a static arm 20 in generally the same arrangement as described with reference to the first example. The hinged and static arms 25, 20 are connected by a hydraulic cylinder 28, which swings the hinged arm 25 around the pivot point relative to the static arm 20 as previously described. The line L passes over the static sheave or roller 21, and passes underneath a first active sheave 26a, which is provided with a first oscillator device 27a, and over a second active sheave 26b, which is vibrated by a second oscillator device 27b. Typically, the oscillator devices 27a, 27b are connected to the winch assembly via damper devices 29a, and 29b. Typically, as shown in FIG. 3, the first oscillator device 27a can be mounted with its first active sheave 26a on the hinged arm 25, and the downward swinging movement of the hinged arm 25 in relation to the static arm 20 typically moves the line into the serpentine configuration shown in FIG. 3, by expansion of the hydraulic cylinder 24, to move the active sheave with its hinged side below the line and pick it up on the upper edge of the sheave 26b. The hydraulic cylinder 24 is then expanded to lower the hinged arm while retracting hydraulic cylinder 24. This brings the oscillator head into contact with the line L to apply vibrations directly to the line L. The second oscillator device 27b is typically mounted on a translation device optionally comprising a hydraulic cylinder 24 arranged to retract to move the sheave in position, and arranged to extend to move clear of the line L. The sheave 26b is typically also hingedly mounted on the piston of the cylinder 24, and optionally has a hydraulic cylinder on the sheave 26b to swing it onto the line and to swing it clear of the line when the hinged arm 25 is lifted clear. The line L is again received in grooves on the sheaves 26a, b, and leaves the sheaves 26a, b with a similar profile to the grooves.

In some alternative examples according to the design of FIG. 3, the first active sheave 26a and its associated oscillator device 27a can be attached to the static arm 20, whereas the outward, second active sheave 26b and its associated oscillator device can be attached via the damper 29b to the outward end of the hinged arm 25, and the line can be moved into the serpentine configuration shown in FIG. 3 by expansion of the hydraulic cylinder 28, to move the hinged arm upwards and move the active sheave 26b up first active sheave 26a mounted on the static arm 20. In either configuration, the line L is held in tension between the sheaves 21, 26a, 26b, and the vibrations are applied to the line via the active sheaves 26a, 26b, generated respectively by the oscillator devices 27a, 27b. The vibrations generated by the oscillator devices 27a, 27b can optionally be in the same phase, or alternatively in a different phase. In some useful examples of the invention, the oscillator devices 27a, 27b are optionally run in different phases, so that the effective tensioning action applied to the line when the first active sheave 26a moves down and the second active sheave 26b moves up is applying an increased amount of tension to the line L as it is being laid onto the drum D. The vibrations can be applied at the same or different amplitudes, frequencies and phases.

Optionally, the oscillator devices 27a, 27b are operated at the same frequency, but in certain examples, the two oscillator devices 27a, 27b can be operated at different frequencies, in order to achieve different compaction results of the line L on the drum D. This can increase vibrations resulting in reduced friction between the fibres and increased tension to produce a more compacted rope. Typically, with the oscillator devices 27a, 27b running at different frequencies, the line L can experience an increase in tension between sheave 26a and 26b and 26b and the drum and therefore an improved alignment of the rope fibres and therefore better rope compaction.

In use, the FIG. 3 arrangement applies the vibrations to the line L in the same manner as the first example, but optionally with a larger deviation of the line, and optionally therefore, a larger amplitude of vibration, leading to an increased effect of compaction as opposed to the amount of compaction of the line L that can be achieved with a single oscillator device.

Referring now to FIG. 4, the arrangement of the static arm 30 and hinged arm 35 in the oscillator head can be modified, so that the passive sheave 31 attached to the static arm 30 is directly below the active sheave 36 mounted on the hinged arm 35 via the oscillator device 37. The hydraulic cylinder 38 retracts in order to bring the active sheave 36 down over the passive sheave 31, to compress the line L between the active and passive sheaves 36, 31, so that the vibrations generated by the oscillator head and transmitted to the line L via the active sheave 36 are applied directly to the compressed line L as it is laid onto the drum D. The clearance between the sheaves 31 and 36 can be adjusted to modify the force applied to the line as it is coming off the sheaves 36, 31. Driving the sheaves 31, 36 closer together also drives the line deeper into the grooves of the sheaves 31, 36, which forces the line to adopt the cross sectional profile of the combined grooves. This can be chosen in combination with the line and the drum to force the line to adopt a particularly advantageous cross-sectional profile as it comes off the sheaves 31, 36, and onto the drum, which assists in the compaction of the line on the drum. For example, the groove profile can be chosen to flatten the line in the grooves between the sheaves, and thereby lay the line onto the drum in a more flattened profile than would be possible without the profile of the grooves. Optionally, the bracket B and arrangement of arms and oscillator devices can be provided immediately adjacent to the drum, so that the line L is subjected to the vibrations of the oscillator device 37 as it is being laid onto the drum D. In a modified version of the FIG. 4 arrangement, both of the sheaves 36, 31 can be provided with oscillator devices, which can optionally be run at the same or different frequencies or amplitudes, and in or out of phase, depending on the desired results to be achieved by the compaction of the line L on the drum D. Optionally the oscillator devices (and optionally the damping devices) can be mounted on the sides of the sheaves.

The active sheave 36 used in the FIG. 4 arrangement (and optionally that used in the FIG. 3 and FIGS. 1 & 2 arrangements) is shown in FIG. 5. The damper device 39 is typically provided on the upper surface of the oscillator device 37, isolating the oscillator device 37 from other components of the system, in this case from the hinged arm 35.

An alternative design of active sheave 36a is shown in FIG. 6, with an oscillator device 37a mounted on the side of the sheave 36a, typically with the damping device 39a, or within the hub of the sheave. The damping device can be mounted on opposite sides of the sheave 36a, between the oscillator devices and the U-shaped bracket, to isolate the side-mounted oscillator devices 37a from the U-shaped bracket on which the sheave 36a is mounted. FIG. 7 shows an end view of a section through the modified sheave 36a.

Referring now to FIG. 8, a modified design of oscillator head has an active sheave 41 with a top-mounted damper mechanism 49, a top-mounted oscillator device 47 similar to the arrangement shown in FIG. 5, a U-shaped bracket with arms extending on either side of the sheave 46, and a friction brake 44 provided on the U-shaped bracket and acting upon the lower part of the rotating sheave 46, so as to retard the rotation of the sheave 46 relative to the U-shaped bracket when the brake 44 is applied. The line L can optionally be constrained within a groove on the sheave 46 by a closure device in the form of a roller 43 held on a hinged arm 42 that is optionally operated by a hydraulic cylinder 48 which is also typically attached to the U-shaped arm folding the sheave 46. As shown in FIG. 9, the modified design of active sheave 41 can be configured to receive the line in the groove by swinging the hinged arm 42 holding the roller 43 away from the sheave 46 by retracting the hydraulic cylinder 48, and then returning the hinged arm 42 into the FIG. 8 position once the line has been received within the groove of the sheave 46.

As in the FIG. 4 example, the clearance between the sheave 46 and the roller 43 can optionally be adjusted during spooling of the line through the sheave 46 to modify the force applied to the line as it is coming off the sheave 46. Driving the roller 43 closer to the sheave 46 drives the line deeper into the groove of the sheave 46, which forces the line to adopt the cross sectional profile of the groove in the sheave 46. This can be chosen in combination with the line and the drum to force the line to adopt a particularly advantageous cross-sectional profile as it comes off the sheave 46, and onto the drum, which assists in the compaction of the line on the drum. The oscillator head again applies vibrations directly to the line L.

As shown in FIG. 10, the brake 44 can optionally comprise a hydraulic or electric brake applied to the hub of the sheave 46, and this can be used in any of the examples described herein.

Referring now to FIG. 11, a modified design of oscillator head has a static arm 50, holding a passive roller sheave 51, and a hinged arm 55 connected to the static arm 50 by means of a hydraulic cylinder 58 as previously described. In the FIG. 11 example, the oscillator device 57 can be substantially as previously described, connected between the hinged arm 55 and a line guide device typically via a damper device 59 in order to focus vibrations directly onto the line, and to isolate vibrations from the hinged arm 55. In the FIG. 11 example, the line guide device adapted to transmit the vibrations from the oscillator device 57 to the line L as it is being laid on the drum D can typically comprise a track device 56 having an endless track 53 circulating around an arrangement of rollers 54, to move axially with the line as it is laid onto the drum D. The track device 56 applies the vibrations over a larger surface area than previous designs, and hence is typically adapted to transmit vibrations more efficiently to the line L. This allows the FIG. 11 arrangement to operate at potentially lower frequencies, and/or lower amplitudes of vibration in order to achieve the same result in terms of the compaction of the line L on the drum D. This also keeps the line L relatively straight compared in comparison to other arrangements.

As in previous examples, the clearance between the sheave 51 and the track device 56 can optionally be adjusted during spooling of the line through the sheave 51 by extending or retracting the cylinder 58 to modify the force applied to the line as it is coming off the sheave 51. Driving the track device 56 closer to the sheave 51 drives the line deeper into the groove of the sheave 51, which forces the line to adopt the cross sectional profile of the groove in the sheave 51, which assists in the compaction of the line on the drum. The oscillator head again applies vibrations directly to the line L.

Modifications of the FIG. 11 arrangement are possible in line with previous examples, for example the oscillator device 56 can be provided immediately above the passive roller 51, or can be located in the same plane, but spaced therefrom in the manner of the FIGS. 1 and 2 examples. The track is typically arranged with the track moving in a straight line, but this is not necessary and the track can be curved. More than one track device 56 can be provided in the manner of the examples shown in FIG. 3. The effect of the FIG. 11 example is that previously described in relation to other examples, namely to apply vibrations to the line L at the point when it is being laid onto the drum D, in order to increase the compaction of the line L, and improve the consistency of the various layers of line on the drum D in terms of their degree of compaction.

A further example similar to that shown in FIG. 11 is shown in FIG. 12, in which the lower arm 60 bears a track device 61, which is typically passive in this example, and the hinged arm 65 that is moved relative to the lower arm 60 by the hydraulic cylinder 68 has an arrangement of damper device 69, oscillator device 67, and track device 66 similar to that described in relation to the FIG. 11 example. The spacing between the track devices 61, 66 can be adjusted by the cylinder 68. In the FIG. 12 example, the line L is compressed between the upper and lower tracks 66, 61 when the cylinder is retracted. Optionally the tracks on the track devices 61, 66 can have grooves to receive and form the line L into a particularly desired profile as it leaves the track devices 61, 66. Optionally, only one of the tracks, e.g. the track 66, is provided with an oscillator device 67, but in modified examples of the FIG. 12 design, both of the tracks 61, 66 can optionally be provided with oscillator devices, and, in keeping with earlier examples, both can be oscillated at the same frequency, or at different frequencies, and by the same amplitude, or by different amplitudes, and either in phase or out of phase depending on the desired effects on the line L as it is being laid onto the drum D.

Optionally the static arm is fixed as in the arm 50, but in the FIG. 12 device, the lower arm 60 can optionally move with its oscillator device 61, by means of a hydraulic cylinder connected between bracket B and lower arm 60 to swing the lower track clear of the line L.

A further design similar to that shown in FIGS. 1 and 2 is shown in FIG. 13. FIG. 13 has a static arm 70 attached to the bracket B, and a hinged arm 75, which is raised and lowered by a hydraulic cylinder 78, and has an active sheave 76, vibrated by an oscillator device 77 as previously described. The line L passes around the passive and active sheaves 71, 76, and is held on the active sheave 76 by a roller assembly 73 which press the line L into the groove on the circumferential edge of the active sheave 76, thereby providing a more effective transmission mechanism for the vibrations that are generated by the oscillator device 77 to be transmitted onto the line L. Two rollers 73 are shown in the FIG. 13 arrangement, but more or less than that can be provided in other examples. The rollers 73 can be swung away from the active sheave 76 in the same manner as has been described in relation to the FIG. 9 example and the device can be provided with a hydraulic cylinder for that purpose. The rollers 73 can also function as closure devices to constrain the line L in the grooves of the sheaves as described in relation to the FIG. 4 and FIG. 8 examples. The active sheave 76, and/or the passive sheave 71 can be provided with a brake in the same manner as shown in FIGS. 8-10.

A single active sheave 76 can optionally be provided in accordance with the general designs shown in FIGS. 1 and 2, or in certain examples, more than one active sheave 76 can be provided, as is shown in FIG. 3. Similar modifications can be made to the FIG. 13 arrangement, in accordance with other examples described herein.

Referring now to FIG. 14, the bracket B, static arm 80, passive sheave 81, hydraulic cylinder 88, hinged arm 85, oscillator device 87 and line L are all generally similar to those described in relation to the FIG. 13 example. However, in the FIG. 14 example, the active sheave 76 has been replaced by an active guide device 86, comprising a U-shaped bracket formed to retain a number of rollers adapted to guide the line L through the active guide device 86. The rollers are provided in an arrangement of three upper rollers 83, and two lower rollers 84, causing the line L to deviate in direction a number of times as it passes through the guide device 86 and around the rollers 84, 83, so that a large surface area of the line L is held against one or more of the rollers 84, 83. The rollers can be simple passive rollers, or can be driven. The entire guide device 86 (and/or one or more of the rollers 84, 83) is vibrated by the oscillator device 87, so that the vibrations thereby generated are transmitted to the line L by the rollers 84, 83. Five rollers are shown in the guide device 86, but more or less can be provided in accordance with other examples of the invention. The rollers 84, 83 can have grooves and can be movable to adjust the spacing between them to constrain the line between the rollers as disclosed in relation to the earlier examples of FIGS. 4 and 8.

Referring now to FIG. 15, the bracket B, static arm 90, passive sheave 91, hydraulic cylinder 98, line L and drum D are all similar to those described for previous examples. In the FIG. 15 example, the oscillator head has a hinged arm 95 extending from a pivot link on the bracket B with its free end provided with an oscillator device 97 and a track device 96, similar to that shown in FIGS. 11 and 12. The track device 96 is arranged to vibrate the line L and the drum D as the line L meets the drum D at a tangent thereto, and vibrations are transmitted directly to the line as it is seated the underlying layers of line that have already been laid on the drum D. The track may be curved to suit the tangent of the drum, and may be grooved to guide or form the line as it is being laid onto the drum D.

An alternative arrangement along these lines is shown in FIG. 16, which has an oscillator head that shares a similar fixed arm 100, bracket B, passive sheave 101, hydraulic cylinder 108, hinged arm 105, line L, drum D, and oscillator device 107, but in the FIG. 16 arrangement, the line L is guided directly onto the drum D by a sheave 106 that is vibrated by the oscillator device 107 in the area of the line as it is being guided onto the drum D, typically transmitting vibrations onto the free part of the line L before it has engaged the drum, and is still arranged at a tangent to the outermost layer of line wound onto the drum, and also transmitting vibrations directly to the layers of line that have already been laid onto the drum. This direct transmission of vibrations onto the line L and the drum D assists in the seating and compaction of the line L on the outermost layers of the line L that have already been laid on the drum D.

Referring now to FIG. 17, this illustrates a possible modification of any of the examples described herein, having an oscillator head wherein a loop of line is formed between two (or more) opposed guide devices such as active sheaves 116a, 116b, which are respectively vibrated by oscillator devices 117a, 117b. Typically, the two sheaves 116a, 116b are vibrated in opposite directions, and typically out of phase in order to apply larger deviations in the tension on the line L as it is being wound onto the drum D. While two active sheaves 116a, 116b are shown in this example, alternative arrangements with more than two active sheaves provided in the loop can be envisaged and are included within the scope of the invention, for example three, four or more active sheaves arranged to define the loop in the line L. Not all of the sheaves in the loop have to be active. This possible modification can be incorporated in previous examples of the invention as described herein. The oscillator devices 117a, 117b can be arranged to vibrate at the same or different frequencies, in or out of phase, and with the same or different amplitudes, depending on the desired compaction characteristics of the line L as it is being wound onto the drum D.

Referring now to FIGS. 18 to 20, a further example of a drum assembly is described, having an oscillator head, which can be used instead of, or in addition to, any of the examples described herein. The oscillator head 200 in the FIG. 18 example has a frame F on which is mounted a guiding device comprising a pair of spooling rollers 210. The rollers 210 are mounted parallel to one another, and perpendicular to the axis of the drum D, on a horizontally travelling carriage 201 which moves from left to right by virtue of a pair of threaded bars which are rotationally mounted on the frame F and a pair of captive nuts which engage with the threaded bars, and which are secured on the carriage 201. FIG. 18 shows a front view of the head 200. The rollers 210 are offset from one another, i.e. not mounted in the same plane, so that the line L passing between the rollers 210 is centred between them, as best shown in FIG. 18, but the offset between the rollers 210 permits the passage of thicker sections of the line L such as may be encountered in a splice between line portions.

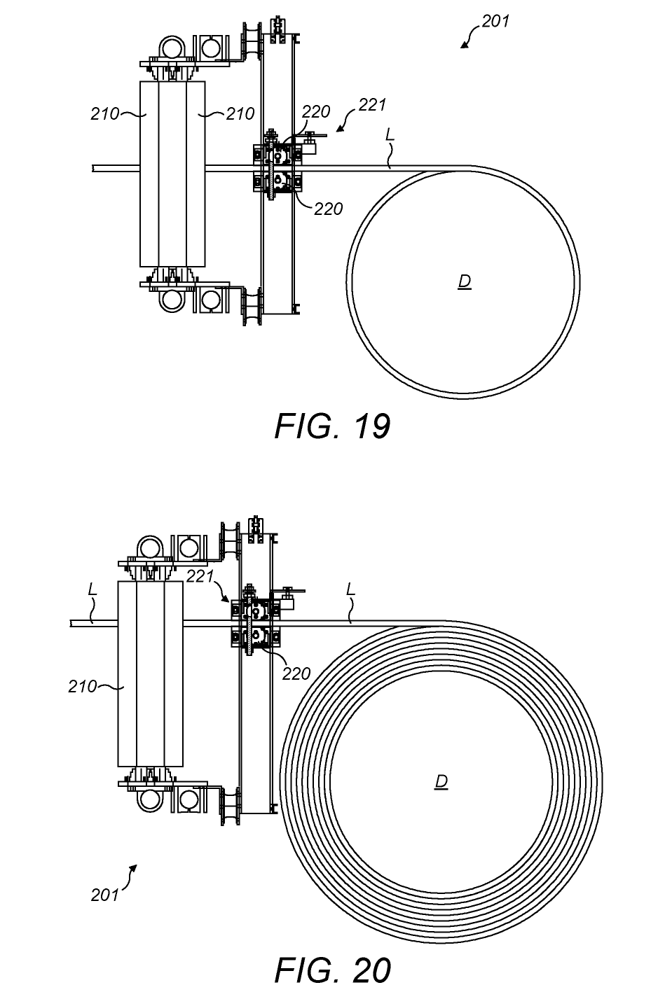

FIG. 19 shows a side view of the carriage 201 of FIG. 18, with the frame F removed for clarity. The carriage 201 has an oscillator device in the form of a pair of vibrating rollers 220, which are held in a parallel arrangement to one another on a horizontal axis, perpendicular to the arrangement of the spooling rollers 210, and parallel to the axis of the drum D. The vibrating rollers 220 are secured to the horizontally travelling carriage 201, and move horizontally left and right along with the spooling rollers 210. However, the vibrating rollers 220 are also secured on a vertically travelling carriage 221, similar to the design of the horizontally travelling carriage 201, but arranged to move vertically rather than horizontally, and thus the vibrating rollers 220 move together in the vertical plane relative to the spooling rollers 210. The vertically travelling carriage 221 can optionally have a motor to drive a threaded bar similar to the arrangement of the horizontally travelling carriage 201.

The spooling rollers 210 guide the sideways movement of the line L as it is spooled onto the drum D, and as rows of line L are added to the drum, the spooling rollers 210 move gradually towards the ends of the drum D, controlling the width of the rows of line L and ensuring consistent packing and maximum compaction. The vertical rollers 220 move horizontally along with the spooling rollers 210, and typically compress the line L between them by virtue of an adjustment mechanism, which alters the spacing between the vibrating rollers 220 in the vertical direction. Optionally, the adjustment mechanism can be remotely controlled, and can be motorised, but it is typically set at a particular spacing dependent on the characteristics of the line L. The vibrating rollers 220 therefore act as a guiding device and closure device, to press the line L into the oscillator device, and compress it to a consistent and flattened shape, optimal for the compaction of the line L on the drum D. This example typically uses fibre rope as the line L, which is typically at its most compact on a drum when flattened, so the vibrating rollers perform the dual purposes of transferring vibrations to the line L and compressing it physically into a more compact profile, before laying it on the drum D.

Typically at least one of the rollers 220 has a vibrating device (which can be any of those previously described) acting on it, and typically housed within it. The vibrations are transferred from the vibrating rollers 220 to the line L as it passes through the vertically travelling carriage 221, and just as it is laid onto the drum D. As the layers of line L on the drum D build up, the vertically travelling carriage 221 and the vibrating rollers 220 translate up and down in the vertical plane in order to maintain a consistent angle of incidence of the line L with respect to the drum.

Examples of this invention can allow a rope or line conditioning system to be low cost and small and therefore possible to transport on the platform/ship requiring the line. Certain examples of the invention permit smaller and simpler devices without necessarily reducing the lifting capacity of the crane. Fibre ropes require a heavier ballasting load than steel wire because they are light and do not have the inherent mass that steel wire has to help tension the rope. Fibre rope drums can therefore require a heavier weight to pretension the rope than a wire rope drum and so examples of this invention are particularly useful for use with fibre ropes, although the invention is not limited thereto. Examples of the present invention usually permit better packing of the line, greater density, less elasticity and less compression of the line when additional layers of line are laid on top.

1. A drum assembly having a drum arranged to receive a line, wherein the assembly has an oscillator head comprising an oscillator device adapted to generate vibrations, wherein the oscillator head is adapted to engage the line and to apply vibrations generated by the oscillator device to the line as the line is being received onto the drum.

2. A drum assembly as claimed in claim 2, including a tensioning device arranged to apply tension to the line as the vibrations are being applied to the line.

3. (canceled)

4. A drum assembly as claimed in claim 1 wherein the oscillator head comprises a guide device that is adapted to divert a path of the line before the line is laid on the drum, and wherein the line is at least partially wound around the guide device.

5. A drum assembly as claimed in claim 4, wherein the guide device comprises a roller device rotationally mounted on the oscillator head, and wherein the roller device rotates with the passage of the line over the roller device.

6. A drum assembly as claimed in claim 5, wherein the roller device has a groove having a cross-sectional profile, and wherein the cross-sectional profile of the groove is different from a resting cross-sectional profile of the line, and provides differential support for the line in the groove thereby forcing the line to adopt the cross-sectional profile of the line as it leaves the groove and is received by the drum.

7. (canceled)

8. (canceled)

9. A drum assembly as claimed in claim 4, wherein the guide device is coated with a high friction material on a surface of the guide device configured to increase the drag on the portion of the line that engages the surface of the guide device.

10. A drum assembly as claimed in claim 4, wherein the line is urged against the guide device by a closure device, and wherein the closure device is movable relative to the guide device to adjust a spacing between the guide device and the closure device.

11. (canceled)

12. A drum assembly as claimed in claim 4, wherein the oscillation device is incorporated within a guide device.

13. A drum assembly as claimed in claim 1, wherein the line has a plane, and the drum has an axis, and wherein the vibrations are applied to the line in a plane that is perpendicular to the plane of the line, and perpendicular to the axis of the drum.

14. A drum assembly as claimed in claim 1, wherein the vibrations are applied in a vertical plane.

15. (canceled)

16. (canceled)

17. A drum assembly as claimed in claim 1, wherein the oscillator head is pivotally mounted to swing in and out of a path of the line.

18. (canceled)

19. A drum assembly as claimed in claim 1, wherein the oscillator head comprises a first and a second oscillator device and wherein the first and second oscillator devices are arranged to apply vibrations to the line in different directions.

20. A drum assembly as claimed in claim 1, wherein the oscillator head incorporates a vibration damper arranged to permit transmission of vibrations to the line but to reduce or prevent the transmission of vibrations to other parts of the drum or assembly.

21. (canceled)

22. A drum assembly as claimed in claim 1, wherein the assembly includes at least one anti-twisting device to reduce twisting of the line relative to the drum.

23. A drum assembly as claimed in claim 1, wherein the line is looped between at least two guide devices, at least one of which is arranged to be vibrated by the oscillator device.

24. A drum assembly as claimed in claim 1, wherein the line comprises a fibre rope.

25. (canceled)

26. (canceled)

27. A method of laying a line on a drum, the method comprising generating vibrations from an oscillator device incorporated within an oscillator head, contacting the line with the oscillator head and applying the vibrations generated by the oscillator head to the line while the line is being laid on the drum.

28. A method as claimed in claim 27, including applying tension to the line while the vibrations are being applied to the line.

29. (canceled)

30. A method as claimed in claim 27 wherein the oscillator head comprises a guide device that diverts a path of the line, and wherein the method includes passing the line around at least a portion of the guide device.

31. A method as claimed in claim 30, wherein the guide device comprises a roller device, and wherein the method includes passing the line around at least a portion of the roller device before laying it on the drum.

32. (canceled)

33. (canceled)

34. A method as claimed in claim 31, including providing the roller device with a high friction surface which engages the line, and wherein the method includes retarding the passage of the line over the guide device by engaging a portion of the line with the high friction surface.

35. (canceled)

36. (canceled)

37. A method as claimed in claim 27, including applying vibrations to the line in a vertical plane that is perpendicular to a plane of the line, and perpendicular to an axis of the drum.

38. (canceled)

39. (canceled)

40. (canceled)

41. (canceled)

42. (canceled)

43. A method as claimed in claim 27, including providing a vibration damper on the oscillator head and absorbing vibrations in the vibration damper to reduce or prevent transmission of vibrations past the vibration damper.

44. (canceled)

45. (canceled)

46. A method as claimed in claim 27, wherein the oscillator device momentarily and sequentially increases and decreases the load on the line as it is being wound onto the drum, causing differential fluctuations in the tension of the line as the line is diverted away in opposite directions from a straight line path to the drum.

47. A method as claimed in claim 27, including differentially vibrating the line more than the drum.

48. A method as claimed in claim 27, wherein the line is composed of line materials, and wherein the line has an axis, and wherein the method includes changing the alignment of the line materials to increase their alignment with the axis of the line.

49. (canceled)

50. (canceled)

51. (canceled)

52. A drum assembly having a drum arranged to receive a line, wherein the assembly has an oscillator head comprising an oscillator device adapted to generate vibrations, wherein the oscillator head is adapted to engage the line and to apply vibrations generated by the oscillator device to the line as the line is being received onto the drum, wherein the oscillator device momentarily and sequentially increases and decreases the load on the line as it is being wound onto the drum, causing differential fluctuations in the tension of the line as the line is diverted away in opposite directions from a straight line path to the drum.
